(19) United States
(12) Patent Application Publication
(10) Pub. No.: US 2026/0138584 A1
(43) Pub. Date: May 21, 2026

(54) USING STEER-BY-WIRE STEERING SYSTEMS FOR ESTIMATING HUMAN VISUAL-MOTOR SKILLS

(71) Applicant: GM Global Technology Operations LLC, Detroit, MI (US)

(72) Inventors: Yubiao Zhang, Troy, MI (US); Bo Yu, Novi, MI (US); Jacob Alan Bond, Rochester Hills, MI (US)

(73) Assignee: GM Global Technology Operations LLC, Detroit, MI (US)

(21) Appl. No.: 18/953,696

(22) Filed: Nov. 20, 2024

(51) Int. Cl. B60W 10/20; B60W 50/14

(52) U.S. Cl. CPC B60W 10/20; B60W 50/14; B60W 2420/40; B60W 2510/20

(57) ABSTRACT

A method includes, while a vehicle is restricted to a parked condition, presenting a visual tracking application on a display of the vehicle, the visual tracking application including a moving-target user interface (UI) element and a pursuit UI element, detecting, using a steer-by-wire (SbW) steering system of the vehicle, movements of a steering wheel by an operator of the vehicle, moving, based on the detected movements, the pursuit UI element in the visual tracking application, and determining, at a plurality of times, a corresponding tracking error between a location of the moving-target UI element in the visual tracking application and a location of the pursuit UI element in the visual tracking application. The method also includes processing the corresponding tracking errors to estimate a visual-motor skill of the operator.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

A steer-by-wire (SbW) steering system for a vehicle is a technology that replaces the mechanical connections between a steering wheel and the front wheels of a vehicle with electronic signals. An operator inputs a desired steering angle through a sensor-equipped steering wheel, which sends the information to a control unit. The control unit then commands electric actuators to adjust wheel angles according to the operator's inputs and the vehicle's speed, stability, and road conditions. A SbW steering system can improve the steering performance, fuel efficiency, and safety of a vehicle, as well as enable new features such as autonomous driving and variable steering ratios.

The present disclosure relates generally to using SbW steering systems for estimating human visual-motor skills.

### SUMMARY

One aspect of the disclosure provides a vehicle including a steer-by-wire (SbW) steering system, a steering wheel configured to control the SbW steering system responsive to operator input, a display, data processing hardware, and memory hardware. The memory hardware is in communication with the data processing hardware and stores instructions that, when executed by the data processing hardware, cause the data processing hardware to perform operations. The operations including restricting the vehicle to a parked condition and, while the vehicle is restricted to the parked condition: presenting a visual tracking application on the display, the visual tracking application including a moving-target user interface (UI) element and a pursuit UI element; detecting, using the SbW steering system, movements of the steering wheel by an operator of the vehicle; moving, based on the detected movements of the steering wheel, the pursuit UI element in the visual tracking application; and determining, at a plurality of times, a corresponding tracking error between a location of the moving-target UI element in the visual tracking application and a location of the pursuit UI element in the visual tracking application; and processing the corresponding tracking errors to estimate a visual-motor skill of the operator.

Implementations of the disclosure may include one or more of the following optional features. In some implementations, moving, based on the detected movements of the steering wheel, the pursuit UI element in the visual tracking application includes moving the pursuit UI element back and forth in the visual tracking application, respectively, as the operator turns the steering wheel back and forth. Moving the pursuit UI element back and forth, respectively, as the operator turns the steering wheel back and forth may include moving the pursuit UI element a pre-determined amount in the visual tracking application responsive to the steering wheel being rotated a pre-determined amount. In some examples, detecting, using the SbW steering system, movements of the steering wheel by the operator includes providing haptic feedback as the steering wheel is rotated.

In some examples, processing the corresponding tracking errors to estimate the visual-motor skill of the operator includes at least one of determining a root mean square of the corresponding tracking errors, determining a frequency above which magnitudes of the corresponding tracking errors satisfy a first threshold, determining a phase lag of the corresponding tracking errors, or using a McRuer crossover model. In some implementations, the operations also include determining whether the estimated visual-motor skill of the operator satisfies a criterion and, when the estimated visual-motor skill of the operator satisfies the criterion, restricting an operation of the vehicle by the operator. Restricting the operation of the vehicle by the operator may include at least one of preventing all driving operations of the vehicle by the operator, limiting a driving operation of the vehicle by the operator, or notifying an emergency contact of the restricted operation of the vehicle by the operator.

In some implementations, the operations also include identifying the operator of the vehicle, and storing the estimated visual-motor skill of the operator in an operator profile associated with the identified operator. The operations may further include obtaining a previously estimated visual-motor skill from the operator profile and determining, based on the estimated visual-motor skill and the previously estimated visual motor skill whether to restrict an operation of the vehicle by the operator. Identifying the operator of the vehicle may include using biometric data or user authentication information to identify the operator.

Another aspect of the disclosure provides a computer-implemented method executed by data processing hardware of a vehicle that causes the data processing hardware to perform operations. The operations including restricting the vehicle to a parked condition and, while the vehicle is restricted to the parked condition: presenting a visual tracking application on the display, the visual tracking application including a moving-target user interface (UI) element and a pursuit UI element; detecting, using the SbW steering system, movements of the steering wheel by an operator of the vehicle; moving, based on the detected movements of the steering wheel, the pursuit UI element in the visual tracking application; and determining, at a plurality of times, a corresponding tracking error between a location of the moving-target UI element in the visual tracking application and a location of the pursuit UI element in the visual tracking application; and processing the corresponding tracking errors to estimate a visual-motor skill of the operator.

Implementations of the disclosure may include one or more of the following optional features. In some examples, moving, based on the detected movements of the steering wheel, the pursuit UI element in the visual tracking application includes moving the pursuit UI element back and forth by a pre-determined amount in the visual tracking application, respectively, as the operator turns the steering wheel back and forth by a pre-determined amount. In some implementations, processing the corresponding tracking errors to estimate the visual-motor skill of the operator includes at least one of determining a root mean square of the corresponding tracking errors, determining a frequency above which magnitudes of the corresponding tracking errors satisfy a first threshold, determining a phase lag of the corresponding tracking errors, or using a McRuer crossover model.

In some implementations, the operations also include determining whether the estimated visual-motor skill of the operator satisfies a criterion and, when the estimated visual-motor skill of the operator satisfies the criterion, restricting an operation of the vehicle by the operator. Restricting the operation of the vehicle by the operator may include at least one of preventing all driving operations of the vehicle by the operator, limiting a driving operation of the vehicle by the operator, or notifying an emergency contact of the restricted operation of the vehicle by the operator.

In some examples, the operations also include identifying the operator of the vehicle, and storing the estimated visual-motor skill of the operator in an operator profile associated with the identified operator. The operations may further include obtaining a previously estimated visual-motor skill from the operator profile, and determining, based on the estimated visual-motor skill and the previously estimated visual motor skill whether to restrict an operation of the vehicle by the operator.

Yet another aspect of the disclosure provides a system including data processing hardware and memory hardware. The memory hardware in communication with the data processing hardware and storing instructions that, when executed by the data processing hardware, cause the data processing hardware to perform operations. The operations including restricting the vehicle to a parked condition and, while the vehicle is restricted to the parked condition: presenting a visual tracking application on the display, the visual tracking application includes a moving-target user interface (UI) element and a pursuit UI element; detecting, using the SbW steering system, movements of the steering wheel by an operator of the vehicle; moving, based on the detected movements of the steering wheel, the pursuit UI element in the visual tracking application; and determining, at a plurality of times, a corresponding tracking error between a location of the moving-target UI element in the visual tracking application and a location of the pursuit UI element in the visual tracking application; and processing the corresponding tracking errors to estimate a visual-motor skill of the operator.

Implementations of the disclosure may include one or more of the following optional features. In some examples, processing the corresponding tracking errors to estimate the visual-motor skill of the operator includes at least one of determining a root mean square of the corresponding tracking errors, determining a frequency above which magnitudes of the corresponding tracking errors satisfy a first threshold, determining a phase lag of the corresponding tracking errors, or using a McRuer crossover model. In some implementations, the operations also include determining whether the estimated visual-motor skill of the operator satisfies a criterion and, when the estimated visual-motor skill of the operator satisfies the criterion, restricting an operation of the vehicle by the operator, restricting the operation of the vehicle by the operator includes at least one of preventing all driving operations of the vehicle by the operator, limiting a driving operation of the vehicle by the operator, or notifying an emergency contact of the restricted operation of the vehicle by the operator.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a view of an example vehicle incorporating a steer-by-wire (SbW) steering system and a human visual-motor skills estimation system in accordance with the principles of the present disclosure.

FIG. 2 is a schematic view of the human visual-motor skills estimation system of FIG. 1.

FIG. 3 is a view of a vehicle dashboard of the vehicle of FIG. 1 incorporating a display for presenting visual tracking application.

FIG. 4 is a schematic view of the SbW steering system of FIG. 1.

FIG. 5 is a view of an example visual tracking application.

FIG. 6 is a schematic view of an example frequency-domain analysis model.

FIG. 7 is a flowchart of an example arrangement of operations for a method of using SbW steering systems for estimating human visual-motor skills.

FIG. 8 is a flowchart of another example arrangement of operations for a method of using SbW steering systems for estimating human visual-motor skills.

FIG. 9 is a flowchart of yet another example arrangement of operations for a method of using SbW steering systems for estimating human visual-motor skills.

FIG. 10 is a flowchart of a still further example arrangement of operations for a method of using SbW steering systems for estimating human visual-motor skills.

FIG. 11 is a flowchart of an even further example arrangement of operations for a method of using SbW steering systems for estimating human visual-motor skills.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Unless expressly stated to the contrary, the phrase “at least one of A, B, or C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least C; and (7) at least one A with at least one B and at least one C. Moreover, unless expressly stated to the contrary, the phrase “at least one of A, B, and C” is intended to refer to any combination or subset of A, B, C such as: (1) at least one A alone; (2) at least one B alone; (3) at least one C alone; (4) at least one A with at least one B; (5) at least one A with at least one C; (6) at least one B with at least one C; and (7) at least one A with at least one B and at least one C. Furthermore, unless expressly stated to the contrary, “A or B” is intended to refer to any combination of A and B, such as: (1) A alone; (2) B alone; and (3) A and B.

Configurations shown and described herein may be used in connection with any type of locally- or remotely operated vehicle (e.g., an automobile, a truck, an airplane, a train, a motorcycle, a bicycle, etc.) that includes a SbW steering system.

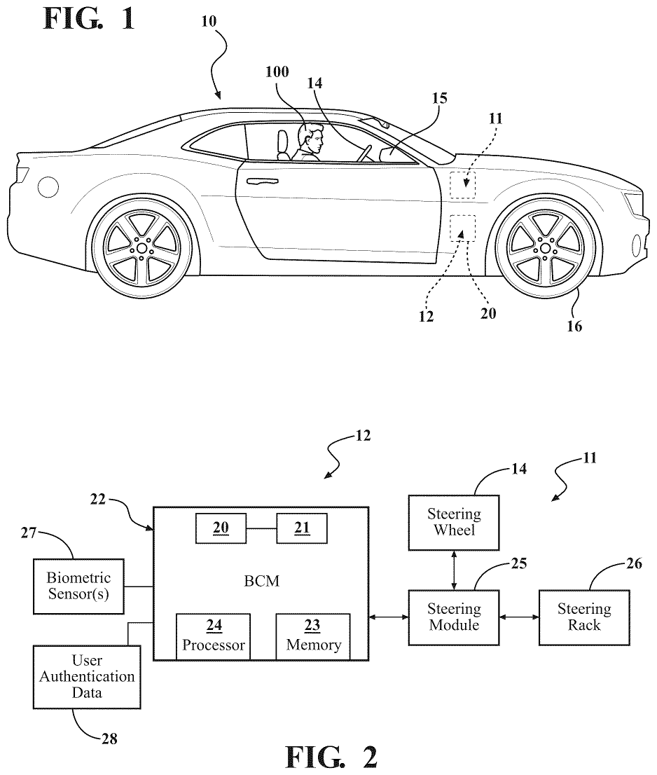

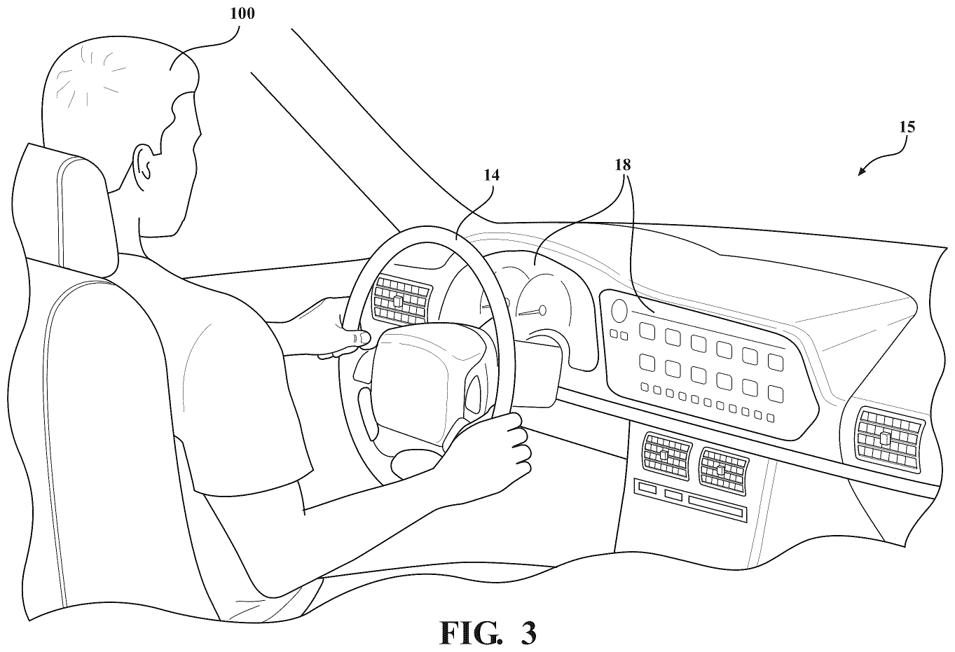

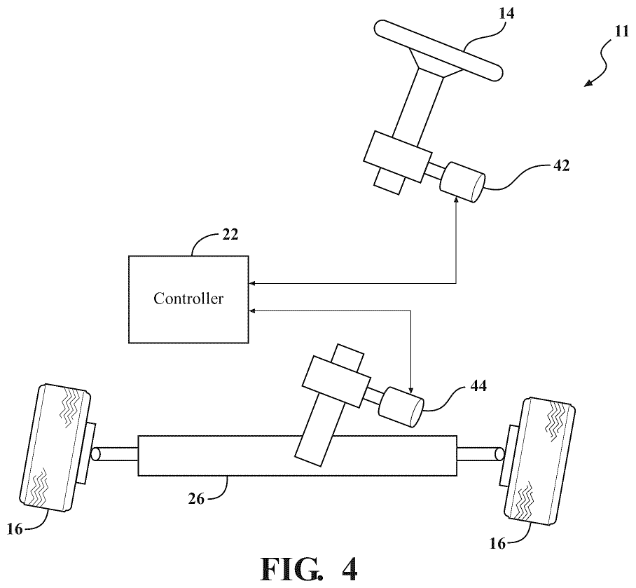

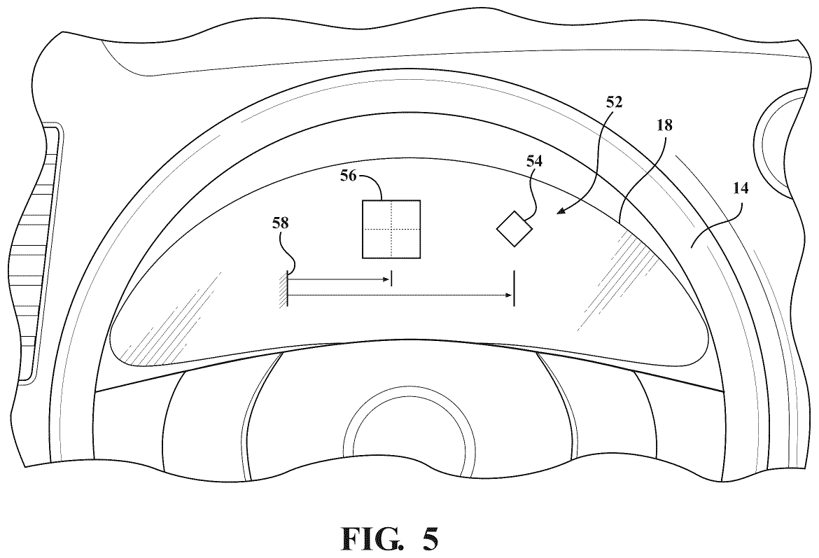

With particular reference to FIGS. 1, 2, 3, and 4, a vehicle 10 including a SbW steering system 11 is shown in conjunction with a human visual-motor skills estimation system 12 that uses the SbW steering system 11 for estimating a visual-motor skill of an operator of the vehicle 10. The SbW steering system 11 replaces mechanical connections between the steering wheel 14 and front wheels 16 of the vehicle 10 with electronic signals. An operator 100 inputs a desired steering angle through a sensor-equipped steering wheel 14 (e.g., using a steering feeling motor 42), which sends the information to a steering module 25 of a control module 22. The steering module 25 then commands electric actuators (e.g., one or more motors 44) of a steering rack 26 to adjust wheel angles according to the operator's inputs and the vehicle's speed, stability, and road conditions. The present disclosure relates generally to using the SbW steering system 11 for estimating human visual-motor skills, which is a novel use of SbW steering systems that has not previously been explored.

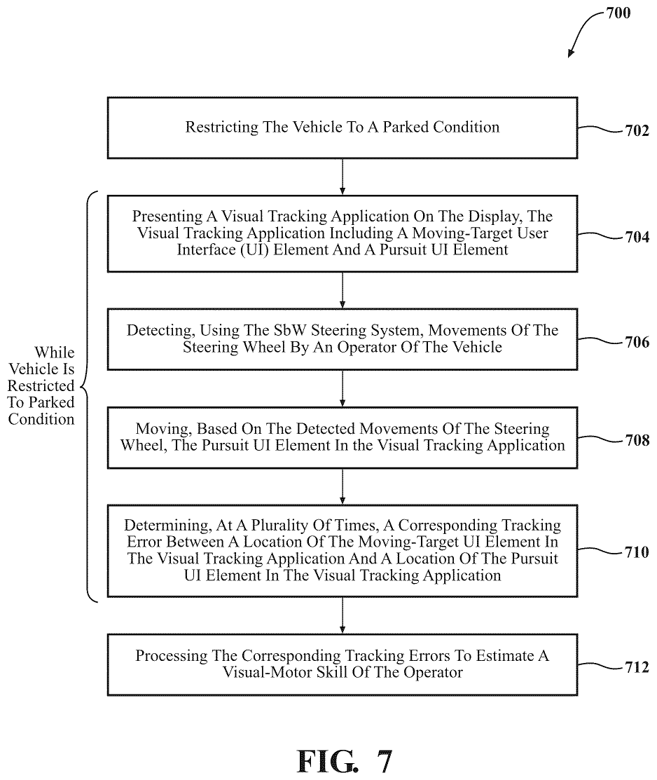

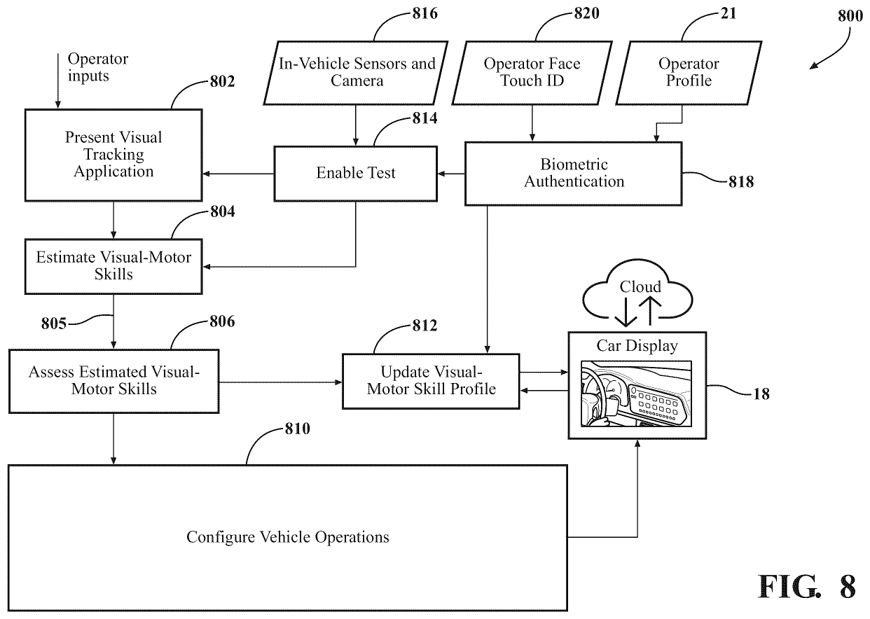

The human visual-motor skills estimation system 12 includes a human visual-motor skills estimation module 20 that may be stored and executed by any control module 22 of the vehicle 10. Specifically, the control module 22 may store machine-readable instructions for executing the operations shown in any of FIGS. 7-11, for example, on memory hardware 23, which may be executed by data processing hardware (e.g., a processor 24) of the control module 22 to perform the operations. In the illustrated example, the human visual-motor skills estimation module 20 is in communication with the SbW steering system 11 for receiving steering user inputs from the steering wheel 14 of the vehicle 10 and controls, based on steering user inputs, a visual tracking application 52 for estimating visual-motor skills.

The human visual-motor skills estimation module 20 restricts the vehicle 10 to a parked condition, and while the vehicle 10 is restricted to the parked condition, uses the SbW steering system 11 for estimating a visual-motor skill of the operator 100. Here, the vehicle 10 is restricted to the parked condition so that the SbW steering system 11 can be safely used for estimating a visual-motor skill of the operator 100. In particular, while restricting the vehicle 10 to a parked condition, the human visual-motor skills estimation module 20 presents a visual tracking application 52 (see FIG. 5) on a display 18 of the vehicle 10. The visual tracking application 52 includes a moving-target user interface (UI) element 54, and a cursor or pursuit UI element 56. The display 18 may be, for example and without limit, a display used to present an instrument panel on a dashboard 15 of the vehicle 10 (e.g., directly in front of the steering wheel 14), a heads-up display, or a display of an infotainment system. In the illustrated example of FIG. 5, the operator 100 moves the steering wheel 14 back and forth to move the pursuit UI element 56 back and forth in the visual tracking application 52, while the human visual-motor skills estimation module 20 moves the moving-target UI element 54 back and forth in the visual tracking application 52. For the visual tracking application 52, the operator 100 is instructed or directed to attempt to move the pursuit UI element 56 so that is moves with, and remains on top of, the moving-target UI element 54. Here, the extent to which the pursuit UI element 56 moves with, and remains on top of, the moving-target UI element 54 represents a visual-motor skill of the operator 100.

The human visual-motor skills estimation module 20 detects, using the SbW steering system 11, movements of the steering wheel 14 by the operator 100 of the vehicle 10 and the visual tracking application 52 moves, based on the detected movements of the steering wheel 14, the pursuit UI element 56 in the visual tracking application 52. In some implementations, the SbW steering system 11 provides haptic feedback (e.g., vibrations or resistance) to the operator 100 via the steering wheel 14 as the operator 100 interacts with the visual tracking application 52. In some examples, the human visual-motor skills estimation module 20 detects a steering angle of the steering wheel 14 (e.g., in degrees), and the visual tracking application 52 determines how much to move the pursuit UI element 56 in pixels using an integrator with a gain of, for example, forty (40). For example, as, or when, the operator 100 turns the steering wheel 14 by a pre-determined amount (e.g., a pre-determined number of degrees), the visual tracking application 52 may move the pursuit UI element 56 by a pre-determined amount (e.g., a pre-determined number of pixels). Here, the gain may be selected to, for example, mimic a natural steering wheel angle to yaw rate relationship, or such that the operator 100 can comfortably turn the steering wheel 14 within a comfortable range while having fine control of the pursuit UI element 56. In some implementations, the moving-target UI element 54 is swept back and forth at varying rates and/or over varying distances.

The human visual-motor skills estimation module 20 determines, at a plurality of times, a corresponding tracking error e between a location of the moving-target UI element 54 in the visual tracking application 52 and a location of the pursuit UI element 56 in the visual tracking application 52. For example, the moving-target UI element 54 may be a distance r from a left side 58 of the visual tracking application 52 while the pursuit UI element 56 is a distance y from the left side 58 of the visual tracking application 52. Here, the tracking error e at a particular time is a difference between y and r. For example, e=r−y, or e=abs(r−y).

Once the visual tracking application 52 is done or stopped, the human visual-motor skills estimation module 20 processes the corresponding tracking errors e to estimate a visual-motor skill of the operator 100. Here, visual-motor skill represents an ability of the operator 100 to integrate or coordinate visual information with motor action. That is, how well the operator 100 can translate a visual image/plan into accurate motor action. In some examples, the human visual-motor skills estimation module 20 determines a root mean square (RMS) of the corresponding tracking errors e as an estimate of visual-motor skill. Additionally, or alternatively, the human visual-motor skills estimation module 20 may determine a frequency above which magnitudes of the corresponding tracking errors e satisfy a first threshold as an estimate of visual-motor skill. Additionally, or alternatively, the human visual-motor skills estimation module 20 may determine a phase lag of the corresponding tracking errors e as an estimate of visual-motor skill. In some examples, the human visual-motor skills estimation module 20 uses frequency-domain analysis (e.g., using a McRuer crossover model) to estimate visual-motor skill.

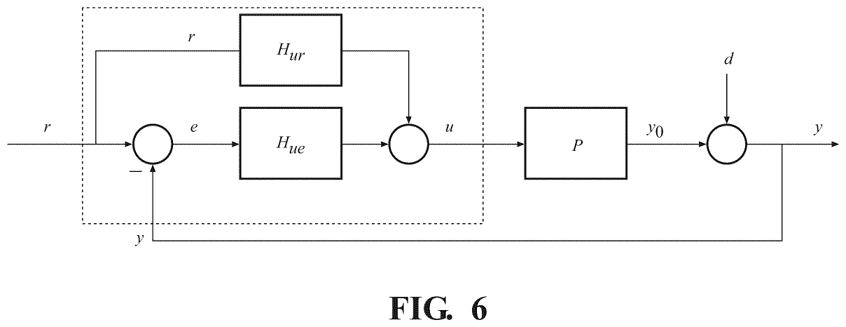

FIG. 6 illustrates an example frequency-domain analysis model 600. Here the frequency-domain analysis model 600 is based on a McRuer crossover model. In the illustrated example, r is the position of the moving-target UI element 54, and y is the position of the pursuit UI element 56 at a particular time. Here,

$$e = r - y \qquad EQN ( 1 )$$

$${H}_{ue} ( s ) P ( s ) = \frac{{ω}_{c} {e}^{- τ s}}{s} \qquad EQN ( 2 )$$

$$r ( t ) = {A}_{3} sin ( {ω}_{3}^{r} t + {φ}_{3} ) \qquad EQN ( 3 )$$

$$d ( t ) = {\sum }_{i = 1}^{10} {B}_{i} sin ( {ω}_{i}^{d} t + {φ}_{i} ) \qquad EQN ( 4 )$$

$$P ( s ) = \frac{40}{s} \qquad EQN ( 5 )$$

where ω_{c} is the crossover frequency, and t is the transport delay time.

In some examples, the human visual-motor skills estimation module 20 determines whether the estimated visual-motor skill of the operator 100 satisfies a criterion, and, when the estimated visual-motor skill of the operator satisfies the criterion, restricts an operation of the vehicle 10 by the operator 100. For example, the human visual-motor skills estimation module 20 may prevent all driving operations of the vehicle by the operator 100, limiting a driving operation of the vehicle by the operator 100 (e.g., restricting driving to below a particular speed, restricting driving to particular environmental conditions, etc.), and/or notify an emergency contact of the restricted operation of the vehicle 10 by the operator 100.

In some implementations, the human visual-motor skills estimation module 20 identifies the operator 100 of the vehicle 10 and stores the estimated visual-motor skill of the operator 100 in an operator profile 21 associated with the identified operator 100. Here, the human visual-motor skills estimation module 20 may obtain a previously estimated visual-motor skill from the operator profile 21, and determine, based on the estimated visual-motor skill and the previously estimated visual motor skill whether to restrict an operation of the vehicle 10 by the operator 100. In some examples, stored visual-motor skill estimates may be tracked or used overtime to assess trends in visual-motor skills due to, for example, illness or disease.

In some examples, identifying the operator 100 includes using biometric data captured by one or more biometric sensors 27 for the operator 100. Additionally, or alternatively, identifying the operator 100 may be based on comparing user authentication data obtained from the operator 100 or a user device associated with the operator 100 with previously stored user authentication data 28.

FIG. 7 is a flowchart of an exemplary arrangement of operations for a computer-implemented method 700 of estimating human visual-motor skills. The operations may be performed by data processing hardware (e.g., the processor 24 of FIG. 1) based on executing instructions stored on memory hardware (e.g., the memory hardware 23 of FIG. 1). Many other ways of implementing the method 700 may be employed. For example, the order of execution of the operations may be changed, and/or one or more of the operations and/or interactions may be changed, eliminated, sub-divided, or combined. Additionally, the operations of FIG. 7 may be carried out sequentially and/or in parallel by, for example, separate processing threads, processors, devices, discrete logic, circuits, etc.

At operation 702, the method 700 includes restricting the vehicle 10 to a parked condition. While the vehicle 10 is restricted to the parked condition, at operation 704, the method 700 includes presenting the visual tracking application 52 on the display 18. The visual tracking application 52 includes a moving-target user interface (UI) element 54 and a pursuit UI element 56. While the vehicle 10 is restricted to the parked condition, at operation 706, the method 700 includes detecting, using the SbW steering system 11, movements of the steering wheel 14 by an operator 100 of the vehicle 10. While the vehicle 10 is restricted to the parked condition, at operation 708, the method 700 includes moving, based on the detected movements of the steering wheel 14, the pursuit UI element 56 in the visual tracking application 52. While the vehicle 10 is restricted to the parked condition, at operation 710, the method 700 includes determining, at a plurality of times, a corresponding tracking error e between a location r of the moving-target UI element 54 in the visual tracking application 52 and a location y of the pursuit UI element 56 in the visual tracking application 52. Thereafter, at operation 712, the method 700 includes processing the corresponding tracking errors e to estimate a visual-motor skill of the operator 100.

FIG. 8 is a flowchart of an exemplary arrangement of operations for a computer-implemented method 800 of estimating human visual-motor skills. The operations may be performed by data processing hardware (e.g., the processor 24 of FIG. 1) based on executing instructions stored on memory hardware (e.g., the memory hardware 23 of FIG. 1). Many other ways of implementing the method 800 may be employed. For example, the order of execution of the operations may be changed, and/or one or more of the operations and/or interactions may be changed, eliminated, sub-divided, or combined. Additionally, the operations of FIG. 8 may be carried out sequentially and/or in parallel by, for example, separate processing threads, processors, devices, discrete logic, circuits, etc.

At operation 802, the method 800 includes presenting the visual tracking application 52 responsive to operator inputs. At operation 804, the method 800 includes determining, at a plurality of times, a corresponding tracking error e between a location r of the moving-target UI element 54 in the visual tracking application 52 and a location y of the pursuit UI element 56 in the visual tracking application 52. Thereafter, at operation 804, the method 800 includes processing the corresponding tracking errors e to estimate a visual-motor skill 805 of the operator 100.

At operation 806, the method 800 includes assessing whether the estimated visual-motor skill 805 of the operator 100 satisfies a criterion, and, when the estimated visual-motor skill 805 of the operator satisfies the criterion, restricts an operation of the vehicle 10 by the operator 100. For example, the human visual-motor skills estimation module 20 may prevent all driving operations of the vehicle by the operator 100, limiting a driving operation of the vehicle by the operator 100 (e.g., restricting driving to below a particular speed, restricting driving to particular environmental conditions, etc.), and/or notify an emergency contact of the restricted operation of the vehicle 10 by the operator 100. In some examples, a previously estimated visual-motor skill is obtained from the operator profile 21 and used to determine whether to restrict an operation of the vehicle 10 by the operator 100. At operation 812, the estimated visual-motor skill is stored in the operator profile 21.

At operation 814, the method 800 includes determining whether to enable the visual-motor skills test at operations 802 and 804. Here, determining whether to enable the visual-motor skills test is based on, for example, data captured by in-vehicle sensors and/or cameras 816, or based on biometric authentication at operation 818. Here, the biometric authentication may be based on, for example, matching biometric data 820, such as a facial image or a fingerprint, with data stored in the operator profile 21. Example in-vehicle sensors 816 include, but are not limited to, an alcohol or drug sensor. Additionally, or alternatively, operation 814 may automatically enable the visual-motor skills test for a teenage operator, a disabled operator, an elderly operator, an operator going to a party, an operator previously charged or convicted of driving under the influence of alcohol or drugs, etc.

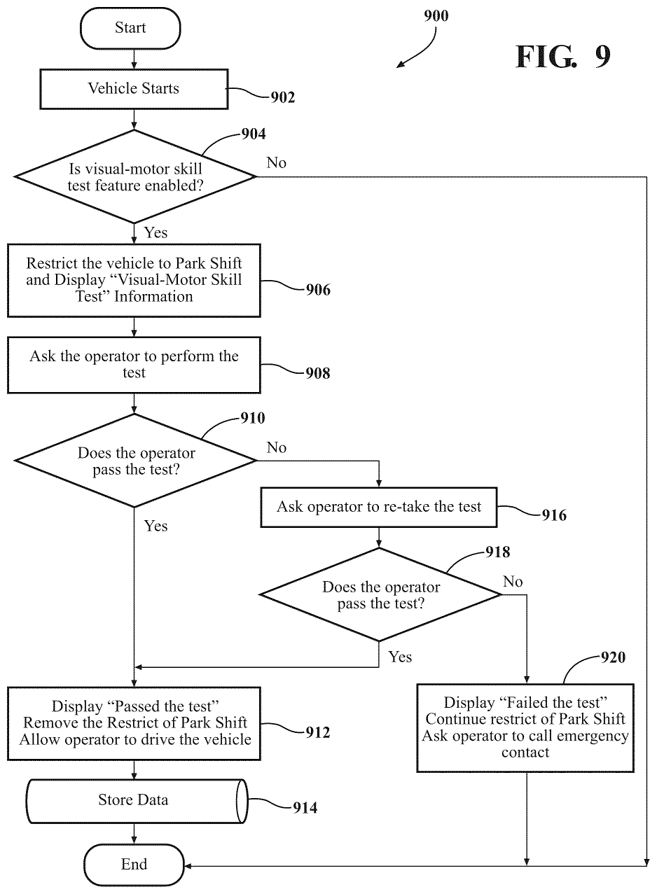

FIG. 9 is a flowchart of an exemplary arrangement of operations for a computer-implemented method 900 of estimating human visual-motor skills. The operations may be performed by data processing hardware (e.g., the processor 24 of FIG. 1) based on executing instructions stored on memory hardware (e.g., the memory hardware 23 of FIG. 1). Many other ways of implementing the method 900 may be employed. For example, the order of execution of the operations may be changed, and/or one or more of the operations and/or interactions may be changed, eliminated, sub-divided, or combined. Additionally, the operations of FIG. 9 may be carried out sequentially and/or in parallel by, for example, separate processing threads, processors, devices, discrete logic, circuits, etc.

At operation 902, the method 900 includes detecting that the vehicle 10 is started. At operation 904, the method 900 includes determining whether the visual-motor skills test is enabled. Here, operation 904 may enable the visual-motor skills test when sensors detect the operator 100 may be under the influence of drugs or alcohol, for a teenage operator, a disabled operator, an elderly operator, an operator going to a party, an operator previously charged or convicted of driving under the influence of alcohol or drugs, etc. If the visual-motor skills test is not enabled, control exits from the method 900.

If the visual-motor skills test is enabled, at operation 906, the method 900 includes restricting the vehicle 10 to a parked condition and displaying the visual tracking application 52 on the display 18 of the vehicle 10. At operation 908, the method 900 includes asking, directing, or instructing the operator 100 to perform the visual tracking test.

At operation 910, the method 900 includes determining whether a visual-motor skill estimated using the visual tracking test satisfies a criterion, i.e., that the operator 100 passed the visual tracking test. If the operator 100 passed the visual tracking test, at operation 912, the method 900 includes displaying on the display 18 that the operator 100 passed the test and removing the restriction that the vehicle 10 remain in a parked condition. At operation 914, the method 900 includes storing the estimated visual-motor skill in the operator profile 21 together with, for example, a date, time, operator identifier, etc.

Returning to operation 910, if the operator 100 did not pass the test, at operation 916, the method 900 includes asking, directing, or instructing the operator 100 to re-take the visual tracking test. At operation 918, the method 900 includes determining whether a visual-motor skill estimated using the repeated visual tracking test satisfies a criterion, i.e., that the operator 100 passed the visual tracking test. If the operator 100 passed the visual tracking test, control proceeds to operation 912. Otherwise, if the operator 100 does not pass the visual tracking test, at operation 920, the method 900 includes displaying on the display 18 that the operator 100 has not passed the test and continuing the restriction that the vehicle 10 remain in a parked condition. For example, the method 900 may prevent all driving operations of the vehicle by the operator 100, limiting a driving operation of the vehicle by the operator 100 (e.g., restricting driving to below a particular speed, restricting driving to particular environmental conditions, etc.), and/or notify an emergency contact of the restricted operation of the vehicle 10 by the operator 100.

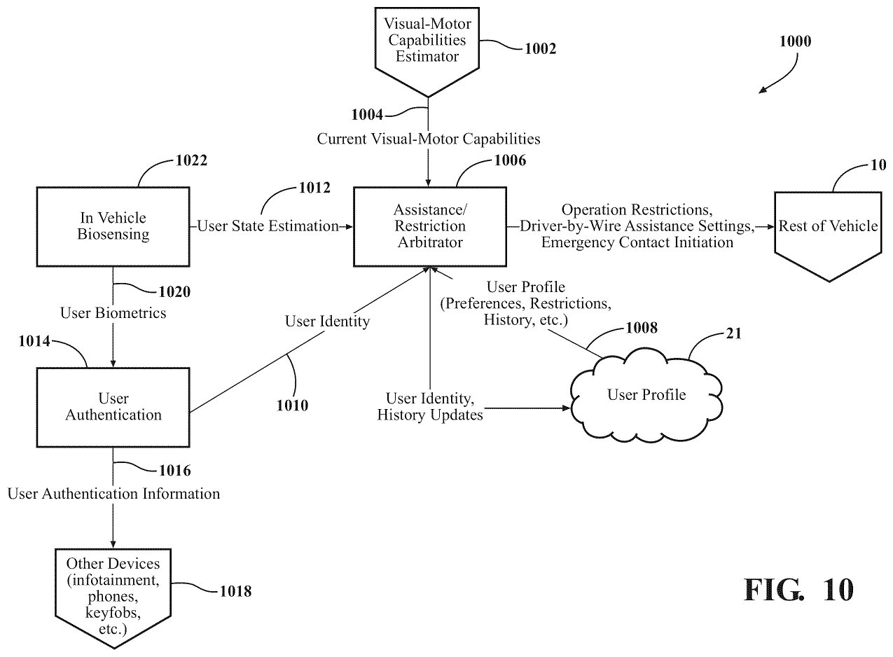

FIG. 10 is a flowchart of an exemplary arrangement of operations for a computer-implemented method 1000 of estimating human visual-motor skills. The operations may be performed by data processing hardware (e.g., the processor 24 of FIG. 1) based on executing instructions stored on memory hardware (e.g., the memory hardware 23 of FIG. 1). Many other ways of implementing the method 1000 may be employed. For example, the order of execution of the operations may be changed, and/or one or more of the operations and/or interactions may be changed, eliminated, sub-divided, or combined. Additionally, the operations of FIG. 10 may be carried out sequentially and/or in parallel by, for example, separate processing threads, processors, devices, discrete logic, circuits, etc.

At operation 1002, the method 1000 includes estimating a visual-motor skill 1004 for an operator 100. At operation 1006, the method 1000 includes arbitrating whether to restrict an operation of the vehicle 10 for the operator 100. For example, operation 1006 may remove any restrictions on operations of the vehicle 10; prevent all driving operations of the vehicle by the operator 100; limit a driving operation of the vehicle by the operator 100 (e.g., restricting driving to below a particular speed, restricting driving to particular environmental conditions, etc.); and/or notify an emergency contact of the restricted operation of the vehicle 10 by the operator 100. As shown, any restrictions applied may be stored in the operator profile 21 for subsequent recall for use in make future arbitrations.

The arbitration at operation 1006 may be based on information 1008 obtained from an operator profile 21 (e.g., preferences, restrictions, history, past visual-motor skill estimations, etc.) for the operator 100, an operator identity 1010, and/or operator state information 1012. At operation 1014, the method 1000 includes authenticating the operator's identity 1010 based on user authentication information 1016 obtained from the operator 100 or from a user device associated with the operator 100, and/or user biometric data 1020 obtained using one or more in-vehicle sensors and/or cameras 1022. Here, the operator identification 1010 may be based on, for example, matching user authentication information 1016 and/or biometric data 1020, such as a facial image or a fingerprint, with data stored in the operator profile 21. Example in-vehicle sensors 816 include, but are not limited to, an alcohol or drug sensor. Here, the operator state information 1012 may reflect whether the operator 100 is under the influence of alcohol or drugs or is sleepy.

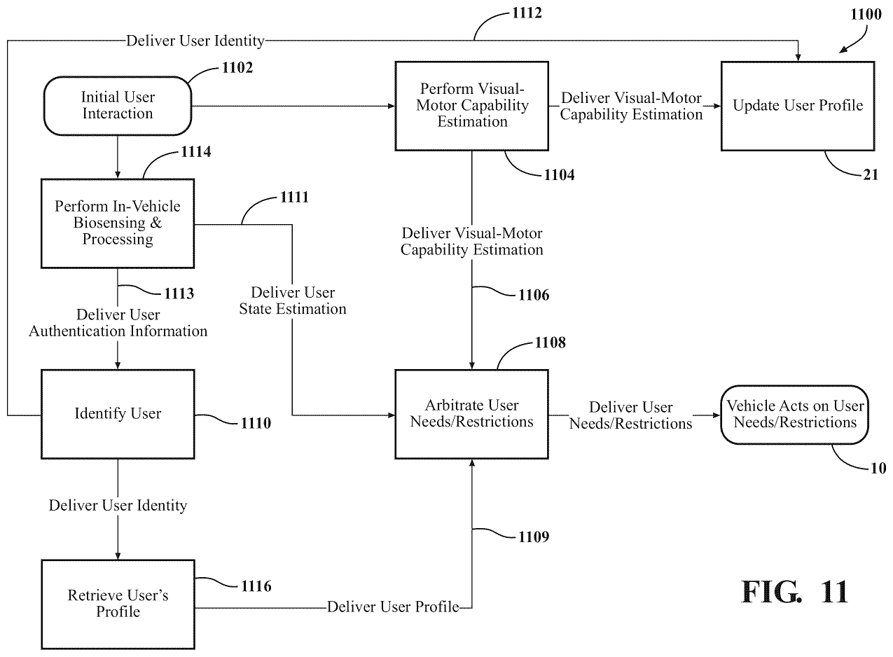

FIG. 11 is a flowchart of an exemplary arrangement of operations for a computer-implemented method 1100 of estimating human visual-motor skills. The operations may be performed by data processing hardware (e.g., the processor 24 of FIG. 1) based on executing instructions stored on memory hardware (e.g., the memory hardware 23 of FIG. 1). Many other ways of implementing the method 1100 may be employed. For example, the order of execution of the operations may be changed, and/or one or more of the operations and/or interactions may be changed, eliminated, sub-divided, or combined. Additionally, the operations of FIG. 11 may be carried out sequentially and/or in parallel by, for example, separate processing threads, processors, devices, discrete logic, circuits, etc.

At operation 1102, the method 1100 includes performing initial interactions with an operator 100. At operation 1104, the method 1100 includes performing a visual-motor skills test for estimating a visual-motor skill 1106 for an operator 100. At operation 1108, the method 1000 includes arbitrating whether to restrict an operation of the vehicle 10 for the operator 100. For example, operation 1108 may remove any restrictions on operations of the vehicle 10; prevent all driving operations of the vehicle by the operator 100; limit a driving operation of the vehicle by the operator 100 (e.g., restricting driving to below a particular speed, restricting driving to particular environmental conditions, etc.); and/or notify an emergency contact of the restricted operation of the vehicle 10 by the operator 100. Any restrictions applied may be stored in the operator profile 21 for subsequent recall for use in make future arbitrations.

The arbitration at operation 1108 may be based on information 1109 obtained from an operator profile 21 (e.g., preferences, restrictions, history, past visual-motor skill estimations, etc.) for the operator 100 and/or operator state information 1111. At operation 1110, the method 1000 includes determining the operator's identity 1112 based on user authentication information obtained from the operator 100 or from a user device associated with the operator 100, and/or user biometric data 1113 obtained using one or more in-vehicle sensors and/or cameras. Here, the operator identification 1112 may be based on, for example, matching user information and/or biometric data 1113, such as a facial image or a fingerprint, with data stored in the operator profile 21. Example in-vehicle sensors include, but are not limited to, an alcohol or drug sensor. Here, the operator state information 1111 may reflect whether the operator 100 is under the influence of alcohol or drugs or is sleepy.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A vehicle comprising:
a steer-by-wire (SbW) steering system;
a steering wheel configured to control the SbW steering system responsive to operator input;
a display;
data processing hardware; and
memory hardware in communication with the data processing hardware and storing instructions that, when executed by the data processing hardware, cause the data processing hardware to perform operations comprising:
restricting the vehicle to a parked condition;
while the vehicle is restricted to the parked condition:
presenting a visual tracking application on the display, the visual tracking application comprising a moving-target user interface (UI) element and a pursuit UI element;
detecting, using the SbW steering system, movements of the steering wheel by an operator of the vehicle;
moving, based on the detected movements of the steering wheel, the pursuit UI element in the visual tracking application; and
determining, at a plurality of times, a corresponding tracking error between a location of the moving-target UI element in the visual tracking application and a location of the pursuit UI element in the visual tracking application; and
processing the corresponding tracking errors to estimate a visual-motor skill of the operator.

2. The vehicle of claim 1, wherein moving, based on the detected movements of the steering wheel, the pursuit UI element in the visual tracking application comprises moving the pursuit UI element back and forth in the visual tracking application, respectively, as the operator turns the steering wheel back and forth.

3. The vehicle of claim 2, wherein moving the pursuit UI element back and forth, respectively, as the operator turns the steering wheel back and forth comprises moving the pursuit UI element a pre-determined amount in the visual tracking application responsive to the steering wheel being rotated a pre-determined amount.

4. The vehicle of claim 1, wherein detecting, using the SbW steering system, movements of the steering wheel by the operator comprises providing haptic feedback as the steering wheel is rotated.

5. The vehicle of claim 1, wherein processing the corresponding tracking errors to estimate the visual-motor skill of the operator comprises at least one of:
determining a root mean square of the corresponding tracking errors;
determining a frequency above which magnitudes of the corresponding tracking errors satisfy a first threshold;
determining a phase lag of the corresponding tracking errors; or
using a McRuer crossover model.

6. The vehicle of claim 1, wherein the operations further comprise:
determining whether the estimated visual-motor skill of the operator satisfies a criterion; and
when the estimated visual-motor skill of the operator satisfies the criterion, restricting an operation of the vehicle by the operator.

7. The vehicle of claim 6, wherein restricting the operation of the vehicle by the operator comprises at least one of:
preventing all driving operations of the vehicle by the operator;
limiting a driving operation of the vehicle by the operator; or
notifying an emergency contact of the restricted operation of the vehicle by the operator.

8. The vehicle of claim 1, wherein the operations further comprise:
identifying the operator of the vehicle; and
storing the estimated visual-motor skill of the operator in an operator profile associated with the identified operator.

9. The vehicle of claim 8, wherein the operations further comprise:
obtaining a previously estimated visual-motor skill from the operator profile; and
determining, based on the estimated visual-motor skill and the previously estimated visual motor skill whether to restrict an operation of the vehicle by the operator.

10. The vehicle of claim 8, wherein identifying the operator of the vehicle comprises using biometric data or user authentication information to identify the operator.

11. A computer-implemented method executed by data processing hardware of a vehicle that causes the data processing hardware to perform operations comprising:
while the vehicle is restricted to a parked condition:
presenting a visual tracking application on a display of the vehicle, the visual tracking application comprising a moving-target user interface (UI) element and a pursuit UI element;
detecting, using a steer-by-wire (SbW) steering system of the vehicle, movements of a steering wheel by an operator of the vehicle;
moving, based on the detected movements of the steering wheel, the pursuit UI element in the visual tracking application; and
determining, at a plurality of times, a corresponding tracking error between a location of the moving-target UI element in the visual tracking application and a location of the pursuit UI element in the visual tracking application; and
processing the corresponding tracking errors to estimate a visual-motor skill of the operator.

12. The computer-implemented method of claim 11, wherein moving, based on the detected movements of the steering wheel, the pursuit UI element in the visual tracking application comprises moving the pursuit UI element back and forth by a pre-determined amount in the visual tracking application, respectively, as the operator turns the steering wheel back and forth by a pre-determined amount.

13. The computer-implemented method of claim 11, wherein processing the corresponding tracking errors to estimate the visual-motor skill of the operator comprises at least one of:
determining a root mean square of the corresponding tracking errors;
determining a frequency above which magnitudes of the corresponding tracking errors satisfy a first threshold;
determining a phase lag of the corresponding tracking errors; or
using a McRuer crossover model.

14. The computer-implemented method of claim 11, wherein the operations further comprise:
determining whether the estimated visual-motor skill of the operator satisfies a criterion; and
when the estimated visual-motor skill of the operator satisfies the criterion, restricting an operation of the vehicle by the operator.

15. The computer-implemented method of claim 14, wherein restricting the operation of the vehicle by the operator comprises at least one of:
preventing all driving operations of the vehicle by the operator;
limiting a driving operation of the vehicle by the operator; or
notifying an emergency contact of the restricted operation of the vehicle by the operator.

16. The computer-implemented method of claim 11, wherein the operations further comprise:
identifying the operator of the vehicle; and
storing the estimated visual-motor skill of the operator in an operator profile associated with the identified operator.

17. The computer-implemented method of claim 16, wherein the operations further comprise:
obtaining a previously estimated visual-motor skill from the operator profile; and
determining, based on the estimated visual-motor skill and the previously estimated visual motor skill whether to restrict an operation of the vehicle by the operator.

18. A system comprising:
data processing hardware; and
memory hardware in communication with the data processing hardware and storing instructions that, when executed by the data processing hardware, cause the data processing hardware to perform operations comprising:
while a vehicle is restricted to a parked condition:
presenting a visual tracking application on a display of the vehicle, the visual tracking application comprising a moving-target user interface (UI) element and a pursuit UI element;
detecting, using a steer-by-wire (SbW) steering system of the vehicle, movements of a steering wheel by an operator of the vehicle;
moving, based on the detected movements of the steering wheel, the pursuit UI element in the visual tracking application; and
determining, at a plurality of times, a corresponding tracking error between a location of the moving-target UI element in the visual tracking application and a location of the pursuit UI element in the visual tracking application; and
processing the corresponding tracking errors to estimate a visual-motor skill of the operator.

19. The system of claim 18, wherein processing the corresponding tracking errors to estimate the visual-motor skill of the operator comprises at least one of:
determining a root mean square of the corresponding tracking errors;
determining a frequency above which magnitudes of the corresponding tracking errors satisfy a first threshold;
determining a phase lag of the corresponding tracking errors; or
using a McRuer crossover model.

20. The system of claim 18, wherein the operations further comprise:
determining whether the estimated visual-motor skill of the operator satisfies a criterion; and
when the estimated visual-motor skill of the operator satisfies the criterion, restricting an operation of the vehicle by the operator, restricting the operation of the vehicle by the operator comprises at least one of:
preventing all driving operations of the vehicle by the operator;
limiting a driving operation of the vehicle by the operator, or
notifying an emergency contact of the restricted operation of the vehicle by the operator.
